(19) United States
(12) Patent Application Publication
(10) Pub. No.: US 2012/0232966 A1
(43) Pub. Date: Sep. 13, 2012

(54) IDENTIFYING PREDETERMINED OBJECTS IN A VIDEO STREAM CAPTURED BY A MOBILE DEVICE

(75) Inventors: Matthew A. Calman, Charlotte, NC (US); Erik Stephen Ross, Charlotte, NC (US); Alfred Hamilton, Charlotte, NC (US)

(73) Assignee: BANK OF AMERICA CORPORATION, Charlotte, NC (US)

(21) Appl. No.: 13/342,051

(22) Filed: Jan. 1, 2012

Related U.S. Application Data
(60) Provisional application No. 61/450,213, filed on Mar. 8, 2011.
(60) Provisional application No. 61/478,408, filed on Apr. 22, 2011.

(51) Int. Cl. G06K 9/00; G06Q 30/06; G06Q 20/32; G06Q 30/02

(52) U.S. Cl. 705/14.1; 382/103; 705/26.1; 705/35

(57) ABSTRACT

A system for processing a video stream is disclosed. The system includes a processing device configured for analyzing the surrounding environment represented in the video stream for at least one predetermined object. At least one predetermined object is identified within the surrounding environment. The object(s) to be identified may be predetermined based on at least one user preference. The system alerts the user once a predetermined object is identified. Information associated with identified predetermined object is presented to the user. In one embodiment, the information is presented via augmented reality such that one or more virtual objects are superimposed over the video stream. The virtual objects may be interactive.

### CROSS-REFERENCE TO RELATED APPLICATIONS

This application claims priority to U.S. Provisional Patent Application Ser. No. 61/450,213, filed Mar. 8, 2011, entitled “Real-Time Video Image Analysis Applications for Commerce Activity,” and U.S. Provisional Patent Application Ser. No. 61/478,408, filed Apr. 22, 2011, entitled “Identifying Predetermined Objects in a Video Stream Captured by a Mobile Device,” the entirety of each of which is incorporated herein by reference.

### BACKGROUND

Modern handheld mobile devices, such as smart phones or the like, combine multiple technologies to provide the user with a vast array of capabilities. For example, many smart phones are equipped with significant processing power, sophisticated multi-tasking operating systems, and high-bandwidth Internet connection capabilities. Moreover, such devices often have additional hardware and/or software that provide features and functionality that are becoming increasingly more common and standardized. Such features and functionality include, but are not limited to, location-determining functionality, such as Global Positioning System (GPS) functionality; hardware and/or software for sensing operational conditions of the devices or even the ambient conditions in which the devices are located, such as accelerometers and high-resolution video cameras.

As the hardware capabilities of such mobile devices have increased, so too have the software applications that control and operate the hardware. One such example of innovative software is a category known as augmented reality (AR), or more generally referred to as mediated reality. One such example of an AR presentation application platform is Layar®, available from Layar®, Amsterdam, the Netherlands.

The Layar® application platform analyzes location data and compass direction data in combination with information related to the objects, locations or other elements shown in the video stream to create browse-able “hot-spots” or “tags” that are superimposed on the mobile device display, resulting in an experience described as “reality browsing”.

However, the Layar® application platform strictly utilizes GPS and compass data in order to create the “reality browsing.” The Layar® application platform is incapable of actually identifying objects within a video stream. Furthermore, the Layar® platform is unable to “search” for predetermined objects in order to alert a user that a desired (or undesired) object is in the proximity.

Therefore, a need exists to implement video analysis and present it to the user as AR or the like, to assist the user of mobile devices with identifying predetermined objects within the environment.

### SUMMARY OF INVENTION

The following presents a summary of certain embodiments of the present invention. This summary is not intended to be a comprehensive overview of all contemplated embodiments, and is not intended to identify key or critical elements of all embodiments nor delineate the scope of any or all embodiments. Its sole purpose is to present certain concepts and elements of one or more embodiments in a summary form as a prelude to the more detailed description that follows.

Methods, apparatus, systems and computer program products are described herein that provide for using video analysis to process video streams and, more specifically, to identify one or more predetermined objects within the surrounding environment and present information associated with the identified object(s) to the user, which information may be presented via AR or the like. The methods, apparatus, systems, and computer program products may additionally provide for alerting the user that a predetermined object has been identified. In one embodiment, the user is presented with information pertaining to, and/or alerted to, the proximity of the predetermined object(s). Through the use of vision object recognition, objects, logos, artwork, products, locations and other features of a predetermined object (referred to herein as attributes) that can be recognized from the surrounding environment represented in the video stream can be identified and matched to stored data or data that can be accessed in real-time (collectively, “preexisting data”) and that is associated with such attributes of the predetermined object(s) to assist with searching for and identifying the predetermined object(s). In one embodiment, the preexisting data that is identified and matched to the attributes of the predetermined object(s) from the surrounding environment represented in the video stream is specific to one or more financial institutions. For example, the preexisting data may comprise customer financial behavior history, customer credit score, customer purchase power/transaction history, vendor information (contact information, account information, payment requirements and acceptable forms of payment, etc.), information regarding products and services (e.g., costs, availability, etc.), and/or other financial information concerning the customer. In this regard, embodiments of the present invention leverage institutional or proprietary financial data that is uniquely specific to a particular financial institution to provide information to users in connection with the video stream analysis.

To the accomplishment of the foregoing and related objectives, the embodiments of the present invention comprise the function and features hereinafter described. The following description and the referenced figures set forth a detailed description of the present invention, including certain illustrative examples of the one or more embodiments. The functions and features described herein are indicative, however, of but a few of the various ways in which the principles of the present invention may be implemented and used and, thus, this description is intended to include all such embodiments and their equivalents.

In one embodiment of the present invention, a method is disclosed for processing a video stream. The method includes analyzing, via a processing device, the surrounding environment represented in the video stream for at least one predetermined object. The method further includes identifying the at least one predetermined object within the surrounding environment. Additionally, the method includes alerting a user that at least one predetermined object has been identified. Finally, the method includes presenting information associated with the at least one predetermined object to the user.

In one embodiment of the method, the processing device comprises the processor of a mobile device such that the surrounding environment is analyzed with a mobile device. In one embodiment, the mobile device comprises a camera capable of image and/or video capture. In one embodiment, the mobile device is operated in the “always on” mode to continuously analyze the surrounding environment. In one embodiment, the method further includes presenting the user with an option to purchase at least one of a product or a service. In one embodiment, the option to purchase is presented via the mobile device. In another embodiment, the method further includes transmitting payment information via a wireless connection to purchase a product or service.

In one embodiment of the method, the at least one predetermined object is identifiable by a least one marker associated with the object. In one embodiment, the at least one marker utilized in identifying the at least one predetermined object is not location-based.

In one embodiment of the method, the at least one predetermined object is predetermined via the processing device based on at least one user input preference. In one embodiment, the at least one user input preference comprises at least one attribute of at least one of a business, a product, or a service. In another embodiment, the at least one attribute may include at least one offer for at least one of a product or a service.

In one embodiment of the method, the information associated with the at least one predetermined object is presented to the user on a display of a mobile device as a virtual object overlaying a real-time video stream of the surrounding environment. In one embodiment, the virtual object is interactive.

In one embodiment of the method, the at least one predetermined object comprises at least one of a product or a service. In another embodiment, the at least one predetermined object is a business. In another embodiment, wherein the at least one predetermined object is a business, the business is identified due to the business being a seller of at least one of a product or a service.

In still another embodiment of the method, the step of alerting the user includes at least one of an audible sound, vibration, or a combination thereof.

In yet another embodiment, the method further includes transmitting financial data and/or other user-specific data to a financial institution.

In another embodiment of the present invention, a system for processing a video stream is provided. The system includes a processing device configured for analyzing the surrounding environment represented in the video stream for at least one predetermined object. The processing device is further configured for identifying the at least one predetermined object within the surrounding environment. Additionally, the processing device is further configured for alerting a user that at least one predetermined object has been identified. Finally, the processing device is further configured for presenting information associated with the at least one predetermined object to the user.

In one embodiment of the system, the system comprises a mobile device and wherein the mobile device comprises the processing device. In one embodiment, a camera may be an accessory to the mobile device. The camera may be attached to the mobile device or associated with the mobile device remotely. The camera is configured to provide image and/or video capture. In one embodiment, the mobile device is operated in the “always on” mode to continuously analyze the surrounding environment. In one embodiment, the processing device is further configured for presenting the user with an option to purchase at least one of a product or a service. In one embodiment, the option to purchase is presented via the mobile device. In another embodiment, the processing device is further configured for transmitting payment information via a wireless connection to purchase a product or service. The system may comprise a mobile device or multiple mobile devices collecting data.

In one embodiment of the system, the at least one predetermined object is identifiable by a least one marker associated with the object. In one embodiment, the at least one marker utilized in identifying the at least one predetermined object is not location-based.

In one embodiment of the system, the at least one predetermined object is predetermined via the processing device based on at least one user input preference. In one embodiment, the at least one user input preference comprises at least one attribute of at least one of a business, a product, or a service. In another embodiment, the at least one attribute may include at least one offer for at least one of a product or a service.

In one embodiment of the system, the information associated with the at least one predetermined object is presented to the user on a display of a mobile device as a virtual object overlaying a real-time video stream of the surrounding environment. In one embodiment, the virtual object is interactive.

In one embodiment of the system, the at least one predetermined object comprises at least one of a product or a service. In another embodiment, the at least one predetermined object is a business. In another embodiment, wherein the at least one predetermined object is a business, the business is identified due to the business being a seller of at least one of a product or a service.

In still another embodiment of the system, alerting the user includes at least one of an audible sound, vibration, or a combination thereof.

In yet another embodiment of the system, the processing devices is further configured for transmitting financial data and/or other user-specific data to a financial institution.

In another embodiment of the present invention, a computer program product for processing a video stream is provided. The computer program product includes a non-transitory computer readable medium comprising one or more computer-readable code portions configured for analyzing the surrounding environment represented in the video stream for at least one predetermined object; identifying the at least one predetermined object within the surrounding environment; alerting a user that at least one predetermined object has been identified; and presenting information associated with the at least one predetermined object to the user.

In one embodiment of the computer program product, the non-transitory computer readable medium comprises at least a portion of a mobile device. In one embodiment, the mobile device comprises a camera capable of image and/or video capture. In one embodiment, the mobile device is operated in the “always on” mode to continuously analyze the surrounding environment. In one embodiment, the one or more computer-readable code portions are further configured for presenting the user with an option to purchase at least one of a product or a service. In one embodiment, the option to purchase is presented via the mobile device. In another embodiment, the one or more computer-readable code portions are further configured for transmitting payment information via a wireless connection between a mobile device and a contactless payment terminal.

Additionally, in one embodiment of the computer program product, the at least one predetermined object is identifiable by a least one marker associated with the object. In one embodiment, the at least one marker utilized in identifying the at least one predetermined object is not location-based.

In one embodiment of the computer program product, the at least one predetermined object is predetermined via the computer program product based on at least one user input preference. In one embodiment, the at least one user input preference comprises at least one attribute of at least one of a business, a product, or a service. In one embodiment, the at least one attribute may include at least one offer for at least one of a product or a service.

In one embodiment of the computer program product, the information associated with the at least one predetermined object is presented to the user on a display of a mobile device as a virtual object overlaying a real-time video stream of the surrounding environment. In one embodiment, the virtual object is interactive.

In one embodiment of the computer program product, the at least one predetermined object comprises at least one of a product or a service. In another embodiment, the at least one predetermined object is a business. In another embodiment, wherein the at least one predetermined object is a business, the business is identified due to the business being a seller of at least one of a product or a service.

In still another embodiment of the computer program product, alerting the user includes at least one of an audible sound, vibration, or a combination thereof.

In yet another embodiment, the one or more computer-readable code portions are further configured for transmitting financial data and/or other user-specific data to a financial institution.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram illustrating a mobile device, in accordance with an embodiment of the invention;

FIG. 2 is a block diagram illustrating an AR environment, in accordance with an embodiment of the invention;

FIG. 3 is a block diagram illustrating a mobile device, in accordance with an embodiment of the invention;

FIG. 4 is a flow diagram illustrating a method for processing a video stream, in accordance with one embodiment of the present invention;

FIG. 5 is a mixed block and flow diagram illustrating a system for processing a video stream captured by a mobile device, in accordance with one embodiment of the present invention;

FIG. 6 is a block diagram illustrating a contactless payment environment, in accordance with an embodiment of the invention;

FIG. 7 is a block diagram illustrating the contactless payment terminal of FIG. 6, in accordance with an embodiment of the invention; and

FIG. 8 illustrates a mobile wallet, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in one or more software modules (also referred to herein as computer-readable code portions) executed by a processor or processing device and configured for performing certain functions, or in a combination of the two. A software module may reside in RAM memory, flash memory, ROM memory, EPROM memory, EEPROM memory, registers, a hard disk, a removable disk, a CD-ROM, or any other form of non-transitory storage medium known in the art. An exemplary storage medium may be coupled to the processing device, such that the processing device can read information from, and write information to, the storage medium. In the alternative, the storage medium may be integral to the processing device. Further, in some embodiments, the processing device and the storage medium may reside in an Application Specific Integrated Circuit (ASIC). In the alternative, the processing device and the storage medium may reside as discrete components in a computing device. Additionally, in some embodiments, the events and/or actions of a method or algorithm may reside as one or any combination or set of codes or code portions and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions, code, or code portions on a computer-readable medium. Computer-readable media includes both non-transitory computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

In accordance with embodiments of the invention, the term “financial institution” refers to any organization in the business of moving, investing, or lending money, dealing in financial instruments, or providing financial services. This includes commercial banks, thrifts, federal and state savings banks, savings and loan associations, credit unions, investment companies, merchants, insurance companies and the like.

Thus, methods, systems, apparatus, computer programs and the like are herein disclosed that provide for processing video streams, including analysis of the video stream to identify predetermined objects within the surrounding environment and presenting information associated with identified predetermined objects to the user. In one embodiment, the information is presented via AR. The methods, apparatus, systems, and computer program products may additionally provide for alerting the user that the at least one predetermined object has been identified. Through the use of vision object recognition, objects, logos, artwork, products, locations, mascots, brand names, brand spokespersons, characters, television personalities associated with the brand, and other features of a predetermined object (referred to herein as attributes) that can be recognized from the surrounding environment represented in the video stream can be identified and matched to preexisting data and that is associated with such attributes of the predetermined objects to assist with searching for and identifying the predetermined objects. In one embodiment, the preexisting data that is identified and matched to the attributes of the predetermined object(s) from the surrounding environment represented in the video stream is specific to financial institutions. For example, the preexisting data may comprise customer financial behavior history, customer credit score, customer purchase power/transaction history, vendor information (contact information, account information, payment requirements and acceptable forms of payment, etc.), information regarding products and services (e.g., costs, availability, etc.), investment data, and/or other financial information concerning the customer. In this regard, embodiments of the present invention leverage institutional or proprietary financial data that is uniquely specific to a particular financial institution to provide information to users in connection with the video stream analysis.

While embodiments discussed herein are generally described with respect to “video streams” or “real-time video” it will be appreciated that the video stream may be captured and stored for later viewing and analysis. Indeed, in some embodiments video is recorded and stored on a mobile device and portions or the entirety of the video may be analyzed at a later time. The later analysis may be conducted on the mobile device or loaded onto a different device for analysis. The portions of the video that may be stored and analyzed may range from a single frame of video (e.g., a screenshot) to the entirety of the video. Additionally, rather than video, the user may opt to take a still picture of the environment to be analyzed immediately or at a later time. Thus, embodiments in which real-time video, recorded video or still pictures are analyzed are contemplated herein.

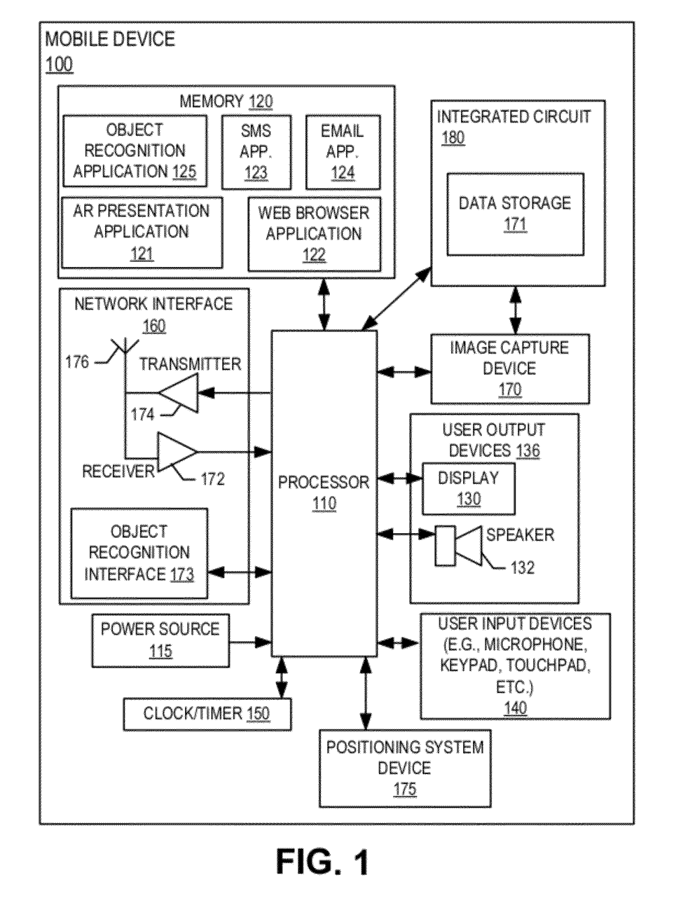

FIG. 1 illustrates an embodiment of a mobile device 100 that may be configured to execute object recognition and Augmented Reality (AR) functionality, in accordance with specific embodiments of the present invention. A “mobile device” 100 may be any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like.

The mobile device 100 may generally include a processor 110 communicably coupled to such devices as a memory 120, user output devices 136, user input devices 140, a network interface 160, a power source 115, a clock or other timer 150, an image capture device 170, a positioning system device 175 (e.g., a Global Positioning System (GPS) device), one or more integrated circuits 180, etc.

In some embodiments, the mobile device and/or the server access one or more databases or data stores (not shown in FIG. 1) to search for and/or retrieve information related to the object and/or marker. In some embodiments, the mobile device and/or the server access one or more data stores local to the mobile device and/or server and in other embodiments, the mobile device and/or server access data stores remote to the mobile device and/or server. In some embodiments, the mobile device and/or server access both a memory and/or data store local to the mobile device and/or server as well as a data store remote from the mobile device and/or server.

The processor 110, and other processors described herein, may generally include circuitry for implementing communication and/or logic functions of the mobile device 100. For example, the processor 110 may include a digital signal processor device, a microprocessor device, and various analog to digital converters, digital to analog converters, and/or other support circuits. Control and signal processing functions of the mobile device 100 may be allocated between these devices according to their respective capabilities. The processor 110 thus may also include the functionality to encode and interleave messages and data prior to modulation and transmission. The processor 110 may additionally include an internal data modem. Further, the processor 110 may include functionality to operate one or more software programs or applications, which may be stored in the memory 120. For example, the processor 110 may be capable of operating a connectivity program, such as a web browser application 122. The web browser application 122 may then allow the mobile device 100 to transmit and receive web content, such as, for example, location-based content and/or other web page content, according to a Wireless Application Protocol (WAP), Hypertext Transfer Protocol (HTTP), and/or the like.

The processor 110 may also be capable of operating applications, such as an object recognition application 125. The object recognition application 14 may be downloaded from a server and stored in the memory 120 of the mobile device 100. Alternatively, the object recognition application 125 may be pre-installed and stored in a memory in the integrated circuit 180. In such an embodiment, the user may not need to download the object recognition application 125 from a server. In some embodiments, the processor 110 may also be capable of operating one or more applications, such as one or more applications functioning as an artificial intelligence (“AI”) engine. The processor 110 may recognize objects that it has identified in prior uses by way of the AI engine. In this way, the processor 110 may recognize specific objects and/or classes of objects, and store information related to the recognized objects in one or more memories and/or databases discussed herein. Once the AI engine has thereby “learned” of an object and/or class of objects, the AI engine may run concurrently with and/or collaborate with other modules or applications described herein to perform the various steps of the methods discussed. For example, in some embodiments, the AI engine recognizes an object that has been recognized before and stored by the AI engine. The AI engine may then communicate to another application or module of the mobile device and/or server, an indication that the object may be the same object previously recognized. In this regard, the AI engine may provide a baseline or starting point from which to determine the nature of the object. In other embodiments, the AI engine's recognition of an object is accepted as the final recognition of the object.

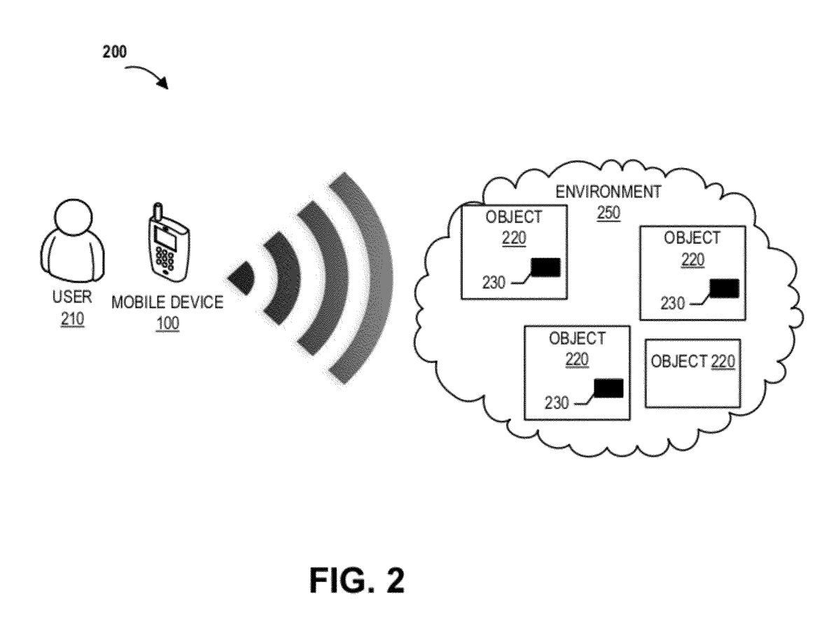

The integrated circuit 180 may include the necessary circuitry to provide the object recognition functionality to the mobile device 100. Generally, the integrated circuit 180 will include data storage 171 which may include data associated with the objects within a video stream that the object recognition application 125 identifies as having a certain marker(s) (discussed in relation to FIG. 2). The integrated circuit 180 and/or data storage 171 may be an integrated circuit, a microprocessor, a system-on-a-integrated circuit, a microcontroller, or the like. As discussed above, in one embodiment, the integrated circuit 180 may provide the functionality to the mobile device 100.

Of note, while FIG. 1 illustrates the integrated circuit 180 as a separate and distinct element within the mobile device 100, it will be apparent to those skilled in the art that the object recognition functionality of integrated circuit 180 may be incorporated within other elements in the mobile device 100. For instance, the functionality of the integrated circuit 180 may be incorporated within the mobile device memory 120 and/or processor 110. In a particular embodiment, the functionality of the integrated circuit 180 is incorporated in an element within the mobile device 100 that provides object recognition capabilities to the mobile device 100. Still further, the integrated circuit 180 functionality may be included in a removable storage device such as an SD card or the like.

The processor 110 may be configured to use the network interface 160 to communicate with one or more other devices on a network. In this regard, the network interface 160 may include an antenna 176 operatively coupled to a transmitter 174 and a receiver 172 (together a “transceiver”). The processor 110 may be configured to provide signals to and receive signals from the transmitter 174 and receiver 172, respectively. The signals may include signaling information in accordance with the air interface standard of the applicable cellular system of the wireless telephone network that may be part of the network. In this regard, the mobile device 100 may be configured to operate with one or more air interface standards, communication protocols, modulation types, and access types. By way of illustration, the mobile device 100 may be configured to operate in accordance with any of a number of first, second, third, and/or fourth-generation communication protocols and/or the like. For example, the mobile device 100 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 100 may also be configured to operate in accordance with non-cellular communication mechanisms, such as via a wireless local area network (WLAN) or other communication/data networks.

The network interface 160 may also include an object recognition interface 173 in order to allow a user to execute some or all of the above-described processes with respect to the object recognition application 125 and/or the integrated circuit 180. The object recognition interface 173 may have access to the hardware, e.g., the transceiver, and software previously described with respect to the network interface 160. Furthermore, the object recognition interface 173 may have the ability to connect to and communicate with an external data storage on a separate system within the network as a means of recognizing the object(s) in the video stream.

As described above, the mobile device 100 may have a user interface that includes user output devices 136 and/or user input devices 140. The user output devices 136 may include a display 130 (e.g., a liquid crystal display (LCD) or the like) and a speaker 132 or other audio device, which are operatively coupled to the processor 110. The user input devices 140, which may allow the mobile device 100 to receive data from a user, may include any of a number of devices allowing the mobile device 100 to receive data from a user, such as a keypad, keyboard, touch-screen, touchpad, microphone, mouse, joystick, other pointer device, button, soft key, and/or other input device(s).

The mobile device 100 may further include a power source 115. Generally, the power source 115 is a device that supplies electrical energy to an electrical load. In one embodiment, power source 115 may convert a form of energy such as solar energy, chemical energy, mechanical energy, etc. to electrical energy. Generally, the power source 115 in a mobile device 100 may be a battery, such as a lithium battery, a nickel-metal hydride battery, or the like, that is used for powering various circuits, e.g., the transceiver circuit, and other devices that are used to operate the mobile device 100. Alternatively, the power source 115 may be a power adapter that can connect a power supply from a power outlet to the mobile device 100. In such embodiments, a power adapter may be classified as a power source “in” the mobile device.

The mobile device 100 may also include a memory 120 operatively coupled to the processor 110. As used herein, memory may include any computer readable medium configured to store data, code, or other information. The memory 120 may include volatile memory, such as volatile Random Access Memory (RAM) including a cache area for the temporary storage of data. The memory 120 may also include non-volatile memory, which can be embedded and/or may be removable. The non-volatile memory may additionally or alternatively include an electrically erasable programmable read-only memory (EEPROM), flash memory or the like.

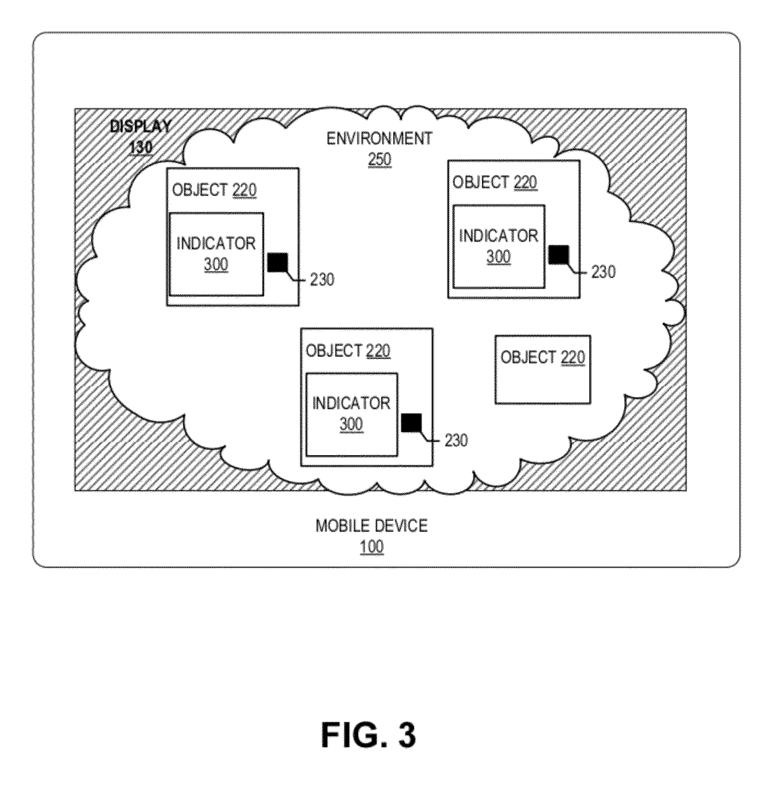

The memory 120 may store any of a number of applications or programs which comprise computer-executable instructions/code executed by the processor 110 to implement the functions of the mobile device 100 described herein. For example, the memory 120 may include such applications as an object recognition application 125, an augmented reality (AR) presentation application 121 (described infra. in relation to FIG. 3), a web browser application 122, a Short Message Service (SMS) application 123, an electronic mail (i.e., email) application 124, etc.

Referring to FIG. 2, a block diagram illustrating an object recognition experience 200 in which a user 210 utilizes a mobile device 100 to capture a video stream that includes an environment 250 is shown. As denoted earlier, the mobile device 100 may be any mobile communication device. The mobile device 100 has the capability of capturing a video stream of the surrounding environment 250. The video capture may be by any means known in the art. In one particular embodiment, the mobile device 100 is a mobile telephone equipped with an image capture device 170 capable of video capture.

The environment 250 contains a number of objects 220. Some of such objects 220 may include a marker 230 identifiable to an object recognition application that is either executed on the mobile device 100 or within the wireless network. A marker 230 may be any type of marker that is a distinguishing feature that can be interpreted by the object recognition application to identify specific objects 220. For instance, a marker 230 may be alpha-numeric characters, symbols, logos, shapes, ratio of size of one feature to another feature, a product identifying code such as a bar code, electromagnetic radiation such as radio waves (e.g., radio frequency identification (RFID)), architectural features, color, etc. In some embodiments, the marker 230 may be audio and the mobile device 100 may be capable of utilizing audio recognition to identify words or unique sounds broadcast. The marker 230 may be any size, shape, etc. Indeed, in some embodiments, the marker 230 may be very small relative to the object 220 such as the alpha-numeric characters that identify the name or model of an object 220, whereas, in other embodiments, the marker 230 is the entire object 220 such as the unique shape, size, structure, etc.

In some embodiments, the marker 230 is not actually a physical marker located on or being broadcast by the object. For instance, the marker 230 may be some type of identifiable feature that is an indication that the object 220 is nearby (e.g., a tag or placard near the object). In some embodiments, the marker 230 for an object 220 may actually be the marker 230 for a different object 220. For example, the mobile device 100 may recognize a particular building as being “Building A.” Data stored in the object recognition data storage may indicate that “Building B” is located directly to the east and next to “Building A.” Thus, markers 230 for an object 220 that are not located on or being broadcast by the object 220 are generally based on fixed facts about the object 220 (e.g., “Building B” is next to “Building A”). However, it is not a requirement that such a marker 230 be such a fixed fact. The marker 230 may be anything that enables the mobile device 100 to interpret to a desired confidence level what the object is. For another example, the mobile device 100 may identify a particular person as a first character from a popular show, and thereafter utilize the information that the first character is nearby features of other characters to interpret that a second character, a third character, etc. are nearby, whereas without the identification of the first character, the features of the second and third characters may not have been used to identify the second and third characters. This example may also be applied to objects outside of people.

The marker 230 may also be or include social network data, such as data retrieved or communicated from the Internet, such as tweets, blog posts, Facebook posts, various types of messages and/or the like. In other embodiments, the marker 230 is provided in addition to social network data as mentioned above. For example, the mobile device 100 may capture a video stream and/or one or more still shots including a large gathering of people. In this example, as above, one or more people dressed as characters in costumes may be present at a specified location. The mobile device 100, object recognition application 121, and/or the AR presentation application 125 may identify several social network indicators, such as posts, blogs, tweets, messages, and/or the like indicating the presence of one or more of the characters at the specified location. In this way, the mobile device 100 and associated applications may communicate information regarding the social media communications to the user and/or use the information regarding the social media communications in conjunction with other methods of object recognition. For example, the mobile device 100 object recognition application 121, and/or the AR presentation application 125 performing recognition of the characters at the specified location may confirm that the characters being identified are in fact the correct characters based on the retrieved social media communications. This example may also be applied objects outside of people.

In some embodiments, the mobile device 100 and/or server access one or more other servers, social media networks, applications and/or the like in order to retrieve and/or search for information useful in performing an object recognition. In some embodiments, the mobile device 100 and/or server accesses another application by way of an application programming interface or API. In this regard, the mobile device 100 and/or server may quickly search and/or retrieve information from the other program without requiring additional authentication steps or other gateway steps.

While FIG. 2 illustrates that the objects 220 with markers 230 only include a single marker 230, it will be appreciated that the object 220 may have any number of markers 230 with each equally capable of identifying the object 220. Similarly, multiple markers 66 may be identified by the mobile device 100 and associated applications such that the combination of the markers 230 may be utilized to identify the object 220. For example, the mobile device 100 may utilize facial recognition markers 230 to identify a person and/or utilize a separate marker 230, such as the clothes the person is wearing to confirm the identification to the desired confidence level that the person is in fact the person the mobile device identified. For example, the facial recognition may identify a person as a famous athlete, and thereafter utilize the uniform the person is wearing to confirm that it is in fact the famous athlete.

In some embodiments, a marker 230 may be the location of the object 220. In such embodiments, the mobile device 100 may utilize Global Positioning System (GPS) hardware and/or software or some other location determining mechanism to determine the location of the user 210 and/or object 220. As noted above, a location-based marker 230 could be utilized in conjunction with other non-location-based markers 230 identifiable and recognized by the mobile device 100 to identify the object 220. However, in some embodiments, a location-based marker may be the only marker 230. For instance, in such embodiments, the mobile device 100 may utilize GPS software to determine the location of the user 210 and a compass device or software to determine what direction the mobile device 100 is facing in order to identify the object 220. In still further embodiments, the mobile device 100 does not utilize any GPS data in the identification. In such embodiments, markers 230 utilized to identify the object 220 are not location-based.

FIG. 3 illustrates a mobile device 100, specifically the display 130 of the mobile device 100, wherein the device 100 has executed an object recognition application 125 and an AR presentation application 121 to present within the display 130 indications of recognized objects within the live video stream (i.e., surrounding environment 250). The mobile device 100 is configured to rely on markers 230 to identify objects 220 that are associated with product offers, products with extended warranties, new products and the like, and indicate to the user 210 the identified objects 220 by displaying an indicator 300 on the mobile device display 130 in conjunction with display of the live video stream. As illustrated, if an object 220 does not have any markers 230 (or at least enough markers 230 to yield object identification), the object 220 will be displayed without an associated indicator 300.

The object recognition application 125 may use any type of means in order to identify desired objects 220. For instance, the object recognition application 125 may utilize one or more pattern recognition algorithms to analyze objects in the environment 250 and compare with markers 230 in data storage 171 which may be contained within the mobile device 100 (such as within integrated circuit 180) or externally on a separate system accessible via the connected network. For example, the pattern recognition algorithms may include decision trees, logistic regression, Bayes classifiers, support vector machines, kernel estimation, perceptrons, clustering algorithms, regression algorithms, categorical sequence labeling algorithms, real-valued sequence labeling algorithms, parsing algorithms, general algorithms for predicting arbitrarily-structured labels such as Bayesian networks and Markov random fields, ensemble learning algorithms such as bootstrap aggregating, boosting, ensemble averaging, combinations thereof, and the like.

Upon identifying an object 220 within the real-time video stream, the AR presentation application 121 is configured to superimpose an indicator 300 on the mobile device display 130. The indicator 300 is generally a graphical representation that highlights or outlines the object 220 and may be activatable (i.e., include an embedded link), such that the user 210 may “select” the indicator 300 and retrieve information related to the identified object. The information may include any desired information associated with the selected object and may range from basic information to greatly detailed information. In some embodiments, the indicator 300 may provide the user 210 with an internet hyperlink to further information on the object 220. The information may include, for example, all types of media, such as text, images, clipart, video clips, movies, or any other type of information desired. In yet other embodiments, the indicator 300 information related to the identified object may be visualized by the user 210 without “selecting” the indicator 300.

In embodiments in which the indicator 300 provides an interactive tab to the user 210, the user 210 may select the indicator 300 by any conventional means, e.g., keystroke, touch, voice command or the like, for interaction with the mobile device 100. For instance, in some embodiments, the user 210 may utilize an input device 140 such as a keyboard to highlight and select the indicator 300 in order to retrieve the information. In a particular embodiment, the mobile device display 130 includes a touch screen that the user may employ to select the indicator 300 utilizing the user's finger, a stylus, or the like.

In some embodiments, the indicator 300 is not interactive and simply provides information to the user 210 by superimposing the indicator 300 onto the display 130. For example, in some instances it may be beneficial for the AR presentation application 121 to merely identify an object 220, e.g., just identify the object's name/title, give brief information about the object, etc., rather than provide extensive detail that requires interaction with the indicator 300. The AR presentation application 121 is capable of being tailored to a user's desired preferences.

Furthermore, the indicator 300 may be displayed at any size on the mobile device display 130. The indicator 300 may be small enough that it is positioned on or next to the object 220 being identified such that the object 220 remains discernible behind the indicator 300. Additionally, the indicator 300 may be semi-transparent or an outline of the object 220, such that the object 220 remains discernible behind or enclosed by the indicator 300. In other embodiments, the indicator 300 may be large enough to completely cover the object 220 portrayed on the display 130. Indeed, in some embodiments, the indicator 300 may cover a majority or the entirety of the mobile device display 130.

The user 210 may opt to execute the object recognition application 125 and AR presentation application 121 at any desired moment and begin video capture and analysis. However, in some embodiments, the object recognition application 125 and AR presentation application 121 includes an “always on” feature in which the mobile device 100 is continuously capturing video and analyzing the objects 220 within the video stream. In such embodiments, the object recognition application 125 may be configured to alert the user 210 that a particular object 220 has been identified. The user 210 may set any number of user preferences to tailor the object recognition and AR presentation experience to their needs. For instance, the user 210 may opt to only be alerted if a certain particular object 220 is identified. Additionally, it will be appreciated that the “always on” feature in which video is continuously captured may consume the mobile device power source 115 more quickly. Thus, in some embodiments, the “always on” feature may disengage if a determined event occurs such as low power source 115, low levels of light for an extended period of time (e.g., such as if the mobile device 100 is in a user's pocket obstructing a clear view of the environment 250 from the mobile device 100), if the mobile device 100 remains stationary (thus receiving the same video stream) for an extended period of time, the user sets a certain time of day to disengage, etc. Conversely, if the “always on” feature is disengaged due to the occurrence of such an event, the user 210 may opt for the “always on” feature to re-engage after the duration of the disengaging event (e.g., power source 115 is re-charged, light levels are increased, etc.).

In some embodiments, the user 210 may identify objects 220 that the object recognition application 125 does not identify and add it to the data storage 171 with desired information in order to be identified and/or displayed in the future. For instance, the user 210 may select an unidentified object 220 and enter a name/title and/or any other desired information for the unidentified object 220. In such embodiments, the object recognition application 125 may detect/record certain markers 230 about the object so that the pattern recognition algorithm(s) (or other identification means) may detect the object 220 in the future. Furthermore, in cases where the object information is within the data storage 171, but the object recognition application 125 fails to identify the object 220 (e.g., one or more identifying characteristics or markers 230 of the object has changed since it was added to the data storage 171 or the marker 230 simply was not identified), the user 210 may select the object 220 and associate it with an object 220 already stored in the data storage 171. In such cases, the object recognition application 125 may be capable of updating the markers 230 for the object 220 in order to identify the object 220 in future video streams.

In addition, in some embodiments, the user 210 may opt to edit the information or add to the information provided by the indicator 300. For instance, the user 210 may opt to include user-specific information about a certain object 220 such that the information may be displayed upon a future identification of the object 220. Conversely, in some embodiments, the user may opt to delete or hide an object 220 from being identified and an indicator 300 associated therewith being displayed on the mobile device display 130.

Furthermore, in some instances, an object 220 may include one or more markers 230 identified by the object recognition application 125 that leads the object recognition application 125 to associate an object 220 with more than one objects 220 in the data storage 171. In such instances, the user 210 may be presented with multiple candidate identifications and may opt to choose the appropriate identification or input a different identification. The multiple candidates may be presented to the user 210 by any means. For instance, in one embodiment, the candidates are presented to the user 210 as a list wherein the “strongest” candidate is listed first based on reliability of the identification. Upon input by the user 210 identifying the object 220, the object recognition application 125 may “learn” from the input and store additional markers 230 in order to avoid multiple identification candidates for the same object 220 in future identifications.

Additionally, the object recognition application 125 may utilize other metrics for identification than identification algorithms. For instance, the object recognition application 125 may utilize the user's location, time of day, season, weather, speed of location changes (e.g., walking versus traveling), “busyness” (e.g., how many objects are in motion versus stationary in the video stream), as well any number of other conceivable factors in determining the identification of objects 220. Moreover, the user 210 may input preferences or other metrics for which the object recognition application 125 may utilize to narrow results of identified objects 220.

In some embodiments, the AR presentation application 121 may have the ability to gather and report user interactions with displayed indicators 300. The data elements gathered and reported may include, but are not limited to, number of offer impressions; time spent “viewing” an offer, product, object or business; number of offers investigated via a selection; number of offers loaded to an electronic wallet and the like. Such user interactions may be reported to any type of entity desired. In one particular embodiment, the user interactions may be reported to a financial institution and the information reported may include customer financial behavior, purchase power/transaction history, and the like.

In various embodiments, information associated with or related to one or more objects 220 that is retrieved for presentation to a user 210 via the mobile device 100 may be permanently or semi-permanently associated with the object 220. In other words, the object 220 may be “tagged” with the information. In some embodiments, a location pointer is associated with an object 220 after information is retrieved regarding the object 220. In this regard, subsequent mobile devices capturing the object 220 for recognition may retrieve the associated information, tags and/or pointers in order to more quickly retrieve information regarding the object 220. In some embodiments, the mobile device 100 provides the user 210 an opportunity to post messages, links to information or the like and associate such postings with the object 220. Subsequent users may then be presenting such postings when their mobile devices capture and recognize an object 220. In some embodiments, the information gathered through the recognition and information retrieval process may be posted by the user 210 in association with the object 220. Such tags and/or postings may be stored in a predetermined memory and/or database for ease of searching and retrieval.

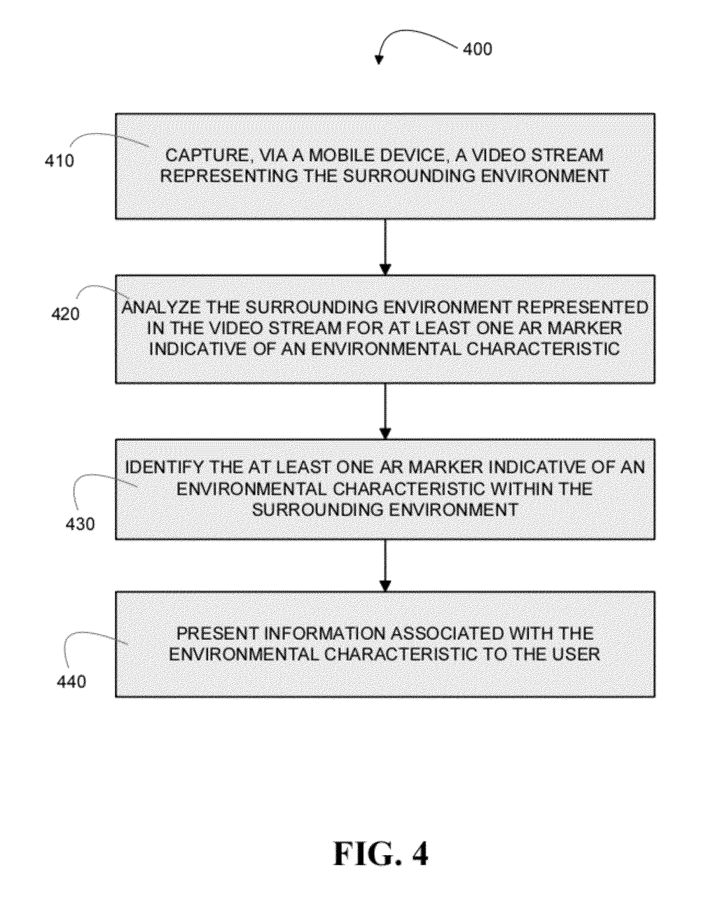

In an exemplary embodiment, the AR presentation application 121 is capable of analyzing the surrounding environment 250 in search of a predetermined object. FIG. 4 illustrates a high-level flow diagram of a method 400 for analyzing the surrounding environment 250 represented by the video stream in search of a predetermined object, according to an embodiment of the invention.

At block 410, the surrounding environment 250 is analyzed in search of at least one predetermined object. As used herein, a “predetermined object” is an object 220 that the AR presentation application 121 searches for either continuously or intermittently. The object 220 may be explicitly predetermined or selected by the user 210 (e.g., the user inputs one or more user preferences to be alerted if the AR presentation application 121 identifies a particular business logo within a video stream) or may be predetermined by the mobile device 100 based on user preferences (e.g., the user inputs preferences to be alerted if the AR presentation application 121 identifies any business that has received OSHA sanctions for polluting the environment). In the latter example, the mobile device 100 may access the data storage 171 or a data storage device within the network (e.g., OSHA database in this example) to determine what objects meet the user inputted criteria or preferences. Thus, in some embodiments, the user 210 may not even be aware of the particular objects the AR presentation application 121 is searching for in the video stream.

The predetermined object(s) may be predetermined by any number or type of user inputted preferences that may require a small number of predetermined objects 220 to be searched for (e.g., “Bigfoot”) or a very large number of predetermined objects 220 to be searched for (e.g., any business that sells chewing gum). In one embodiment, the user 210 may opt to be notified of any business that is offering promotional deals, coupons, or other types of offers. The user preferences may include product, product type, price thresholds or ranges and the like. In additional embodiments, a user may define product or business preferences on an ad hoc basis, such as when visiting a retail location, for example a shopping mall, strip mall or the like. For example, a user may define specific dining preferences and/or specific or desired offers associated with the dining preferences when at a shopping mall.

In one embodiment, the analysis is conducted utilizing a real-time video stream captured by a mobile device 100. Although, in other embodiments, it is contemplated that video or images may be recorded for later analysis. The AR presentation application 121 may be operated in the “always on” mode in order to continuously scan the environment 250 for the predetermined objects or scan intermittently. Thus, in one embodiment, the user 210 actively utilizes the mobile device 100 in search of predetermined objects by viewing the mobile device display 130 as the user 210 pans around scanning for predetermined objects. However, in an alternate embodiment, the user 210 passively utilizes the mobile device 100 in search of predetermined objects. In such embodiments, the mobile device 100 may simply be affixed to or otherwise carried by the user 210 and the mobile device 100 simply scans the images captured and alerts the user if a predetermined object is identified. Additionally, the mobile device 100 may be affixed to a moving vehicle and scan the environment 250 for a predetermined object.

In one embodiment, the predetermined object may be a person or an animal. For example, the user 210 may opt to be alerted if any person on a most wanted criminal list or any person within a missing person database is identified. Furthermore, the user 210 may simply opt to be notified if a particular person is identified such as a person from the user's social network such as Facebook®, Twitter®, Linkedin®, YouTube®, etc. Similarly, the user may opt to search for a lost pet, a particular type of animal, etc.

At block 420, the AR presentation application 121 may identify which objects 220 analyzed by the AR presentation application 121 are associated with business, products, services, people, tangible articles and/or the like that are predetermined objects as defined by the user's inputted preferences, such as a wish list, shopping list, or the like. As described above, the identification is made based on analysis of one or more markers 230 associated with objects 220 in the environment 250. The markers 230 are analyzed by the AR presentation application 121 and compared with words, sounds, logos, artwork, architecture or other object-indicating features or attributes in the data storage 171 to determine what objects 220 within the video stream provide matches (i.e., associations) for the predetermined objects.

At block 430, the mobile device 100 alerts the user 210 that a predetermined object has been identified. The “alert” may be one or more indicators that appear on the mobile device display 130. However, when the AR presentation application is operated in a passive mode (i.e., the user 210 is not attentive to and watching the video stream being analyzed), it is generally preferable that the alerts be of audible signals, vibration of the mobile device 100, Short Message Service/text messages, social network posts, tweets, emails or the like which may identify the object, provide access to an offer or direct the user to the video stream (real-time or recorded) for access to the displayed indicator 300.

At block 440, information associated with the predetermined object is presented to the user 210 via the mobile device display 130 or by alternative means such as SMS/text messages, emails, social networking, such as Facebook®, Twitter®, or other social media platforms, or the like. In most cases, the user 210 will simply opt to be notified that a predetermined object has been identified. Although, in other embodiments, as described above, any type and amount of information associated with the identified object may be available to the user 210 by interacting with the indicator 300, for instance.

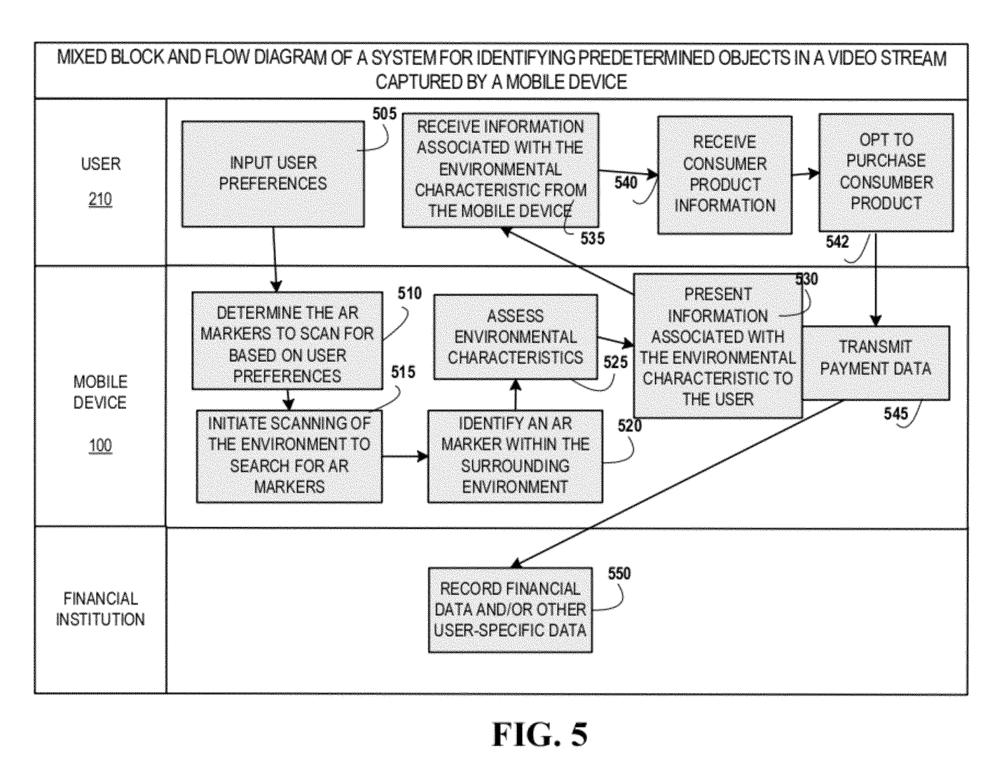

FIG. 5 illustrates a high-level mixed block and flow diagram of a system 500 for identifying predetermined objects in a video stream captured by a mobile device 100. It will be understood that the system 500 illustrated is an exemplary embodiment. As shown, the system 500 includes a user 210, a mobile device 100, and a financial institution.

As represented by block 505, the user 210 inputs user preferences into the AR presentation application 121 of the mobile device 100. The user preferences may be any preference or affinity the user 210 wishes to include as criteria for identifying desired objects 220. Of note, in some embodiments, the user 210 may define the inputted preferences in a manner that the objects 220 that are identified may negatively influence the user's financial transactions. For instance, a user 210 may opt to identify businesses that have outsourced a large percentage of jobs to foreign countries such that the user may be alerted as to which businesses the user does not wish to transact with.

Once the user 210 inputs the desired preferences, the mobile device 100 may access the data storage 171 and/or any other data storage within a network in order to determine what objects meet the user's criteria, which may simply be a specific object 220 the user 210 has selected. Once the mobile device 100 determines the predetermined objects to search for, the mobile device 100 initiates scanning of the environment 250 to search for the predetermined objects, as represented by block 515.

As noted above, the AR presentation application 121 identifies one or more markers 230 associated with each object 220 in order to make object identifications. The markers 230 may be any characteristic, attributes or feature that may assist in identification, including facts such as size, color, shape, location, time, etc. The AR presentation application 121 may additionally be configured in order to discriminately eliminate one or more predetermined objects. For example, if the user 210 inputs preferences that yield the Statute of Liberty as a predetermined object, but the user 210 is presently located in California, the AR presentation application 121 may be configured to not scan for the Statue of Liberty due to the impossibility of it entering the mobile device 100 video stream in California. Such preemptive elimination of objects may assist to improve the overall functionality of the AR presentation application. For instance, elimination of unnecessary objects may prevent the AR presentation application 121 from producing an error such as in instances where the AR presentation application 121 searches for too many predetermined objects and the search is beyond the capabilities of the mobile device processing device 110.

In some embodiments, the information provided by the real-time video stream may be compared to data provided to the system through an API. In this way, the data may be stored in a separate application and be implemented by request from the mobile device and/or server.

As represented by block 520, the mobile device 100 then may identify a predetermined object within the surrounding environment 250. Upon identifying an object, the mobile device 100 alerts the user that the object has been identified as shown in block 525. The alert may be any way to bring the identification to the user's attention. In a particular embodiment, the mobile device display 130 may include an indicator and the mobile device 100 may emit an audible sound and/or vibration or other type of alert as discussed above.

At block 530, the mobile device 100 may present information associated with the identified predetermined object to the user 210, and as illustrated at block 535, the user may receive the information associated with the object. The information displayed to the user may range from a simple identification of the object to a large amount of data associated with the object, as noted above.

In a particular embodiment, the information displayed to the user 210 may include object purchasing information. In such embodiments, the user may opt to purchase the object as shown in block 540. Of course, not all objects that may be identified by the AR presentation application 121 are even capable of being purchased. Furthermore, some businesses that may sell the identified object may not have the capability of accepting payment information from the mobile device 100.

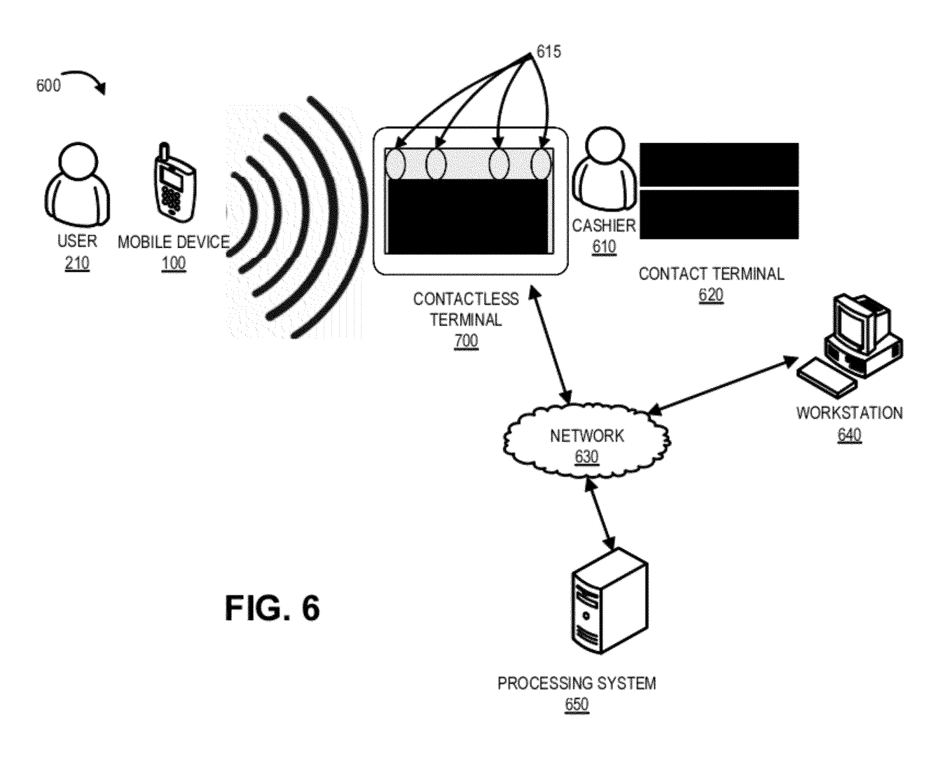

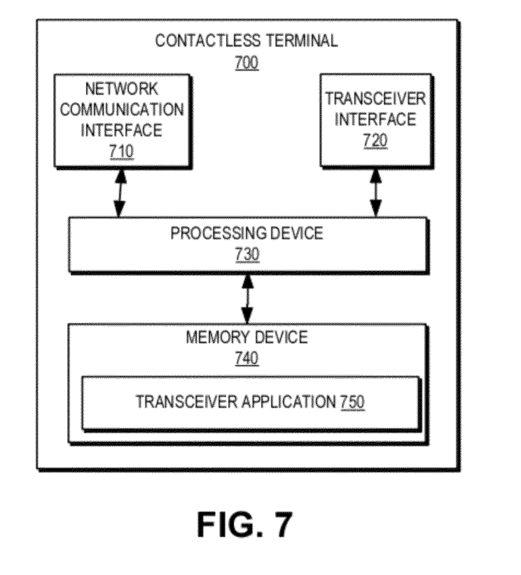

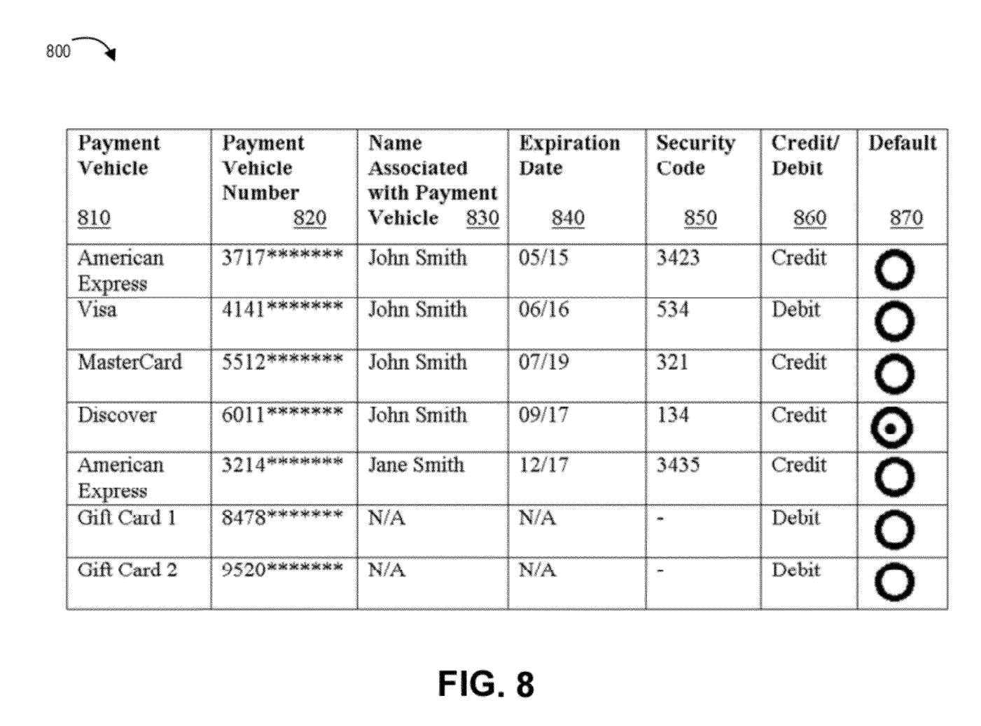

The user 210 may opt to utilize any feasible means in purchasing the identified object. In some embodiments, the business that sells the object may be capable of accepting online orders for the identified object via the Internet, an intranet or other wireless connection utilizing the mobile device 100. In a particular embodiment, the mobile device 100 includes a mobile wallet 800 (FIG. 8) and the business is capable of receiving payment vehicle data from the user's mobile device 100 via a contactless payment terminal 700 (FIGS. 6 and 7) as discussed further below. Thus, as illustrated at block 545, the mobile device 100 may transmit payment data for purchase of the identified object.

As represented by block 550, a financial institution may monitor and record financial data and/or video image analysis user data associated with the object identification. For instance, the data the financial institution may record includes the amount of time the user reviewed the presented information, whether the user 210 was presented with an option to purchase, whether the user 210 purchased the identified object, the price of the object, the frequency in which the user utilizes the AR presentation application 121 to identify and purchase objects, etc. Such information may be beneficial to the financial institution in determining future business strategies, risk behaviors, and credit worthiness.

As noted above, in some embodiments, the user 210 is presented with the option to purchase an identified object 220 utilizing the mobile device 100. For instance, the indicator 300 displayed on the mobile device 100 may include a link, such as, for example, an internet hyperlink, that gives the user 210 the option to purchase the product.

Additionally, the mobile device 100 may be equipped to provide the user 210 the ability to transmit payment information directly from the mobile device 100 to a payment terminal in order to complete a purchase. Referring to FIG. 6, a block diagram illustrating a contactless transaction environment 600 configured for making a contactless transaction via a mobile device 100 is shown. As illustrated, the contactless transaction environment 600 may include a mobile device 100 operable by a user 210 who may be a customer who wishes to make a contactless payment for the identified object 220. The contactless transaction environment 600 may also include a contactless terminal 700 that may be automated or may be operable by a cashier 610. The contactless terminal 700 may permit a user 210 to make a contactless payment with the mobile device 100.

Of course, the environment 600 may also include a contact terminal 620 that may permit a user 210 to make a payment via a contact transaction device such as a payment card that has a magnetic stripe which may be swiped through the contact terminal 620.

The contactless transaction environment 600 may also include a workstation 640 and a processing system 650 that are in electronic communication with the contactless terminal 700 via a network 630, which may be the Internet, an intranet or the like. The user interface 615 situated on the contactless terminal 700 may be any sort of device, such as light emitting diodes (LEDs) for indicating that payment has been received, invalid payment vehicle, exceeded credit limit, etc.

In FIG. 6, the network 630 may include a local area network (LAN), a wide area network (WAN), and/or a global area network (GAN). The network 630 may provide for wireline, wireless, or a combination of wireline and wireless communication between devices in the network. In some embodiments, the network 630 includes the Internet. In some embodiments, the network 630 may include a wireless telephone network.

FIG. 7 illustrates an embodiment of a contactless terminal 700 that is depicted in FIG. 6. The contactless terminal 700 may include various features, such as a network communication interface 710, a processing device 730, a transceiver interface 720, and a memory device 740 that may include a transceiver application 750.

As used with respect to the contactless terminal 700, a “communication interface” may generally include a modem, server, transceiver, and/or other device for communicating with other devices on a network. The network communication interface 710 may be a communication interface having one or more communication devices configured to communicate with one or more other devices in the contactless transaction environment 600, such as the mobile device 100, the workstation 640, the processing system 650, other processing systems, data systems, etc.

In one embodiment, the transceiver interface 720 is a separate module that may generally include a transceiver, i.e., one or more antennas and/or other electronic circuitry, devices, and software, for receiving electronic payment vehicle data when the mobile device 100 is held close to or “tapped” at the contactless terminal 700. In accordance with embodiments of the invention, the term “tap,” “tapped,” “tapping,” etc. may refer to bringing a mobile device close to or within the proximity of a payment terminal so that information can be communicated wirelessly between the mobile device and the payment terminal using short range wireless transmission technology, such near-field communication (NFC) technology, radio-frequency (RF) technology, or the like. Tapping may include physically tapping the mobile device against an appropriate portion of the payment terminal or it may include only waving or holding the mobile device near an appropriate portion of the payment terminal without making physical contact with the payment terminal. In some embodiments, the transceiver interface 720 is part of the network communication interface 710. Furthermore, the transceiver interface 720 may also be used as an interface to send data to the mobile device 100 when the mobile device 100 is held close to or tapped at the contactless terminal 700.

An output device for the transceiver interface 720 may include a display that provides instructions regarding the steps for making a contactless transaction. In some embodiments where the contactless terminal 700 requests authentication, such as a signature, the display may also serve as a touchpad input device to input the user's signature via a stylus. Other output devices may include one or more LEDs or an audio speaker, both which may indicate to the user 210 that data has been successfully received from the mobile device 100. A printer that can print paper receipts or holograms that may also be incorporated into the contactless terminal 700. Other embodiments of the contactless terminal 700 may carry other input and output devices, such as a mouse, keyboard, button, touchpad, touch screen, microphone, speaker, light, joystick, switch, or the like.

As used with respect to the contactless terminal 700, a “processing device,” 730 may generally refer to a device or combination of devices having circuitry used for implementing the communication and/or logic functions of a particular system. For example, a processing device 730 may include a digital signal processor device, a microprocessor device, and various analog-to-digital converters, digital-to-analog converters, and other support circuits and/or combinations of the foregoing. Control and signal processing functions of the system may be allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 730 may be configured to use the network communication interface 710 and/or the transceiver interface 720 to transmit and/or receive data and/or commands to and/or from the other devices that are visible in the contactless payment environment 600.

As used with respect to the contactless terminal 700, a “memory device” may generally refer to a device or combination of devices that store one or more forms of computer-readable media for storing data and/or computer-executable program code/instructions. For example, in one embodiment, the memory device may include any computer memory that provides an actual or virtual space to temporarily or permanently store data and/or commands provided to the processing device when it carries out its functions described herein. In one embodiment, the memory device stores a transceiver application 750. The transceiver application 750 may work in conjunction with the previously described transceiver interface 720 to receive electronic payment vehicle data when the mobile device 100 is held close to or tapped at the contactless terminal 700. In some embodiments, the transceiver application 750 may also be configured to send data to the mobile device 100 when the mobile device 100 is held close to or tapped at the payment terminal 700, or potentially provide a power source 115 to the mobile device 100 in the event the primary power source is depleted.

As illustrated in FIG. 6, a contactless terminal 200 may be connected to a workstation 640 via the network 630. The workstation 640 may be used by the cashier 610 or other personnel to interact with the contactless terminal 700. The workstation 640 may include various features, such as a network communication interface, a processing device, a user interface, and a memory device.

As used with respect to the workstation 640, a “communication interface” may generally include a modem, server, transceiver, and/or other device for communicating with other devices on a network. The network communication interface may be a communication interface having one or more communication devices configured to communicate with one or more other devices on the network 630, such as the contactless terminal 700 and/or contact terminal 620, the processing system 650, other processing systems, data systems, etc.

As used with respect to the workstation 130, a “processing device” may generally refer to a device or combination of devices having circuitry used for implementing the communication and/or logic functions of a particular system as described above. For example, a processing device may include a digital signal processor device, a microprocessor device, and various analog-to-digital converters, digital-to-analog converters, and other support circuits and/or combinations of the foregoing. Control and signal processing functions of the system may be allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device may be configured to use a network communication interface and/or the transceiver interface to transmit and/or receive data and/or commands to and/or from the other devices that are visible in the network 630.

As used with respect to the workstation 640, a “user interface” may generally include a plurality of interface devices and/or software that allow a user to input commands and data to direct the processing device to execute instructions. For example, the user interface may include a graphical user interface (GUI) or an interface to input computer-executable instructions that direct the processing device to carry out specific functions. The user interface may employ certain input and output devices to input data received from the user 210 or the cashier 610 or output data to the user or the cashier 610. These input and output devices may include a display, mouse, keyboard, button, touchpad, touch screen, microphone, speaker, light, joystick, switch, and/or other customer input/output device for communicating with one or more customers. As used with respect to the workstation 640, a “memory device” may generally refer to a device or combination of devices that store one or more forms of computer-readable media for storing data and/or computer-executable program code/instructions. For example, in one embodiment, the memory device may include any computer memory that provides an actual or virtual space to temporarily or permanently store data and/or commands provided to the processing device when it carries out its functions described herein.

As indicated above, in some embodiments, the user 210 may opt to utilize the mobile device 100 to wirelessly transmit payment vehicle data to a contactless terminal 700. Typically, the payment vehicle data is stored within the mobile device 100 or accessible externally through the network. This payment vehicle data is typically contained within a mobile wallet. In accordance with embodiments of the invention, the phrase “mobile wallet” refers to the hardware and/or software in a mobile device that enables the mobile device to be used to make contactless payments at a payment terminal. In accordance with embodiments of the invention, the term “payment vehicle” may refer to an electronic payment vehicle, such as an electronic credit or debit card. The payment vehicle may not be a “card” at all and may instead be account identifying information stored electronically in a mobile device, such as in a cell phone.

Turning to FIG. 8, one embodiment of a mobile wallet 800 is illustrated. Importantly, the mobile wallet 800 of the present invention is not limited to the embodiments shown in the figures. Indeed, the manner in which the “menu” of payment vehicles 810 is presented to the user or the type of additional information stored within the mobile wallet 800 is not critical to the present invention.

As illustrated, information contained within the mobile wallet 800 and capable of being transmitted by the mobile device 100 may include the payment vehicle type 810, the unique payment vehicle account number 820 associated with the payment vehicle 810, the name associated with the payment vehicle 830, the payment vehicle's expiration date 840, the payment vehicle's security code 850, whether the payment vehicle is credit or debit 860 and the default payment vehicle 870 for use in transactions.

Thus, methods, systems, computer programs and the like are herein disclosed that provide for using video analysis to identify predetermined objects within the environment and presenting information associated with identified objects to the user via AR or the like. The methods, apparatus systems, and computer program products may additionally provide for alerting the user to the proximity of the predetermined objects. Through the use of vision object recognition, objects, logos, artwork, products, locations and other features that can be recognized in the video stream can be matched to data associated with such to assist the user with searching for and identifying predetermined objects. In specific embodiments, the data that is matched to the images in the video stream is specific to financial institutions, such as customer financial behavior history, customer purchase power/transaction history and the like. In this regard, many of the embodiments herein disclosed leverage financial institution data, which is uniquely specific to financial institution, in providing information to mobile device users in connection with video stream analysis.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise. In this regard, the term “processor” and “processing device” are terms that are intended to be used interchangeably herein and features and functionality assigned to a processor or processing device of one embodiment are intended to be applicable to or utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

The systems, methods, computer program products, etc. described herein, may be utilized or combined with any other suitable AR-related application. Non-limiting examples of other suitable AR-related applications include those described in the following U.S. Provisional Patent Applications, the entirety of each of which is incorporated herein by reference:

| U.S. | | |
|---|---|---|
| Provisional | | |
| Ser. No. | Filed On | Title |
| 61/450,213 | Mar. 8, 2011 | Real-Time Video Image Analysis |
| | | Applications for Commerce Activity |
| 61/478,409 | Apr. 22, 2011 | Presenting Offers on a Mobile |
| | | Communication Device |
| 61/478,412 | Apr. 22, 2011 | Real-Time Video Analysis for Reward |
| | | Offers |
| 61/478,394 | Apr. 22, 2011 | Real-Time Video Image Analysis for |
| | | Providing Targeted Offers |
| 61/478,399 | Apr. 22, 2011 | Real-Time Analysis Involving Real |
| | | Estate Listings |
| 61/478,402 | Apr. 22, 2011 | Real-Time Video Image Analysis for an |
| | | Appropriate Payment Account |
| 61/478,405 | Apr. 22, 2011 | Presenting Investment-Related |
| | | Information on a Mobile Communication |
| | | Device |
| 61/478,393 | Apr. 22, 2011 | Real-Time Image Analysis for Medical |
| | | Savings Plans |
| 61/478,397 | Apr. 22, 2011 | Providing Data Associated With |
| | | Relationships Between Individuals and |
| | | Images |
| 61/478,400 | Apr. 22, 2011 | Real-Time Image Analysis for Providing |
| | | Health Related Information |
| 61/478,411 | Apr. 22, 2011 | Retrieving Product Information From |
| | | Embedded Sensors Via Mobile Device |
| | | Video Analysis |
| 61/478,403 | Apr. 22, 2011 | Providing Social Impact Information |
| | | Associated With Identified Products or |
| | | Businesses |
| 61/478,407 | Apr. 22, 2011 | Providing Information Associated With |
| | | an Identified Representation of an Object |
| 61/478,415 | Apr. 22, 2011 | Providing Location Identification of |
| | | Associated Individuals Based on |
| | | Identifying the Individuals in |
| | | Conjunction With a Live Video Stream |
| 61/478,419 | Apr. 22, 2011 | Vehicle Recognition |
| 61/478,417 | Apr. 22, 2011 | Collective Network of Augmented |
| | | Reality Users |
| 61/508,985 | Jul. 18, 2011 | Providing Information Regarding |
| | | Medical Conditions |
| 61/508,946 | Jul. 18, 2011 | Dynamically Identifying Individuals |
| | | From a Captured Image |
| 61/508,980 | Jul. 18, 2011 | Providing Affinity Program Information |
| 61/508,821 | Jul. 18, 2011 | Providing Information Regarding Sports |
| | | Movements |
| 61/508,850 | Jul. 18, 2011 | Assessing Environmental Characteristics |
| | | in a Video Stream Captured by a Mobile |
| | | Device |
| 61/508,966 | Jul. 18, 2011 | Real-Time Video Image Analysis for |
| | | Providing Virtual Landscaping |
| 61/508,969 | Jul. 18, 2011 | Real-Time Video Image Analysis for |
| | | Providing Virtual Interior Design |
| 61/508,971 | Jul. 18, 2011 | Real-Time Video Image Analysis for |
| | | Providing Deepening Customer Value |
| 61/508,764 | Jul. 18, 2011 | Conducting Financial Transactions Based |
| | | on Identification of Individuals in an |
| | | Augmented Reality Environment |
| 61/508,973 | Jul. 18, 2011 | Real-Time Video Image Analysis for |
| | | Providing Security |
| 61/508,976 | Jul. 18, 2011 | Providing Retail Shopping Assistance |
| 61/508,944 | Jul. 18, 2011 | Recognizing Financial Document Images |

What is claimed is:

1. A method for processing a video stream, comprising:
analyzing, via a processing device, the surrounding environment represented in the video stream for at least one predetermined object;
identifying the at least one predetermined object within the surrounding environment;
alerting a user that at least one predetermined object has been identified; and
presenting information associated with the at least one predetermined object to the user.

2. The method of claim 1, wherein the processing device comprises the processor of a mobile device.

3. The method of claim 2, wherein the mobile device comprises a camera capable of image and/or video capture.

4. The method of claim 1, wherein the at least one predetermined object is identifiable by at least one marker associated with the object.

5. The method of claim 4, wherein the at least one marker utilized in identifying the at least one predetermined object is not location-based.

6. The method of claim 1, wherein the at least one predetermined object is predetermined via the processing device based on at least one user input preference.

7. The method of claim 6, wherein the at least one user input preference comprises at least one attribute of at least one of a business, a product, or a service.

8. The method of claim 7, wherein the at least one attribute comprises at least one offer for at least one of a product or a service.

9. The method of claim 1, wherein the information associated with the at least one predetermined object is presented to the user on a display of a mobile device as a virtual object overlaying a real-time video stream of the surrounding environment.

10. The method of claim 9, wherein the virtual object is interactive.

11. The method of claim 2, wherein the mobile device is operated in the “always on” mode to continuously analyze the surrounding environment.

12. The method of claim 1, wherein the at least one predetermined object comprises at least one of a product or a service.

13. The method of claim 1, wherein the at least one predetermined object is a business.

14. The method of claim 13, wherein the business is identified due to the business being a seller of at least one of a product or a service.

15. The method of claim 1, wherein the step of alerting the user comprises at least one of an audible sound, vibration, or a combination thereof.

16. The method of claim 1, further comprising presenting the user with an option to purchase at least one a product or a service.

17. The method of claim 2, further comprising transmitting payment information via a wireless connection between the mobile device and a contactless payment terminal.

18. The method of claim 1, further comprising transmitting financial data and/or other user-specific data to a financial institution.

19. A system for processing a video stream comprising:
a processing device configured for:
analyzing the surrounding environment represented in the video stream for at least one predetermined object;
identifying the at least one predetermined object within the surrounding environment;
alerting a user that at least one predetermined object has been identified; and
presenting information associated with the at least one predetermined object to the user.

20. The system of claim 19, further comprising a mobile device and wherein the mobile device comprises the processing device.

21. The system of claim 20, wherein the mobile device further comprises a camera capable of image and/or video capture.

22. The system of claim 19, wherein the at least one predetermined object is identifiable by at least one marker associated with the object.

23. The system of claim 22, wherein the at least one marker utilized in identifying the at least one predetermined object is not location-based.

24. The system of claim 19, wherein the at least one predetermined object is predetermined via the processing device based on at least one user input preference.

25. The system of claim 24, wherein the at least one user input preference comprises at least one attribute of at least one of a business, a product, or a service.

26. The system of claim 25, wherein the at least one attribute comprises at least one offer for at least one of a product or a service.

27. The system of claim 20, wherein the mobile device comprises a display and wherein the information associated with the at least one predetermined object is presented to the user on the display of the mobile device as a virtual object overlaying a real-time video stream of the surrounding environment.

28. The system of claim 27, wherein the virtual object is interactive.

29. The system of claim 20, wherein the mobile device is operated in the “always on” mode to continuously analyze the surrounding environment.

30. The system of claim 19, wherein the at least one predetermined object comprises at least one of a product or a service.

31. The method of claim 19, wherein the at least one predetermined object is a business.

32. The system of claim 31, wherein the business is identified due to the business being a seller of at least one of a product or a service.

33. The system of claim 19, wherein the user is alerted via at least one of an audible sound, vibration, or a combination thereof.

34. The system of claim 19, wherein the processing device is further configured for presenting the user with an option to purchase at least one of a product or a service.

35. The system of claim 20, wherein the processing device is further configured for transmitting payment information via a wireless connection between the mobile device and a contactless payment terminal.

36. The system of claim 19, wherein the processing device is further configured to transmit financial data and/or other user-specific data to a financial institution.

37. A computer program product for processing a video stream comprising a non-transitory computer readable medium comprising one or more computer-readable code portions configured for:
analyzing the surrounding environment represented in the video stream for at least one predetermined object;
identifying the at least one predetermined object within the surrounding environment;
alerting a user that at least one predetermined object has been identified; and
presenting information associated with the at least one predetermined object to the user.

38. The computer program product of claim 37, wherein the non-transitory computer readable medium comprises at least a portion of a mobile device.

39. The computer program product of claim 38, wherein the mobile device further comprises a camera capable of image and/or video capture.

40. The computer program product of claim 37, wherein the at least one predetermined object is identifiable by at least one marker associated with the object.

41. The computer program product of claim 40, wherein the at least one marker utilized in identifying the at least one predetermined object is not location-based.

42. The computer program product of claim 37, wherein the at least one predetermined object is predetermined based on at least one user input preference.

43. The computer program product of claim 42, wherein the at least one user input preference comprises at least one attribute of at least one of a business, a product, or a service.

44. The computer program product of claim 43, wherein the at least one attribute comprises at least one offer for at least one or a product or a service.

45. The computer program product of claim 38, the mobile device comprises a display and wherein the information associated with the at least one predetermined object is presented to the user on the display of the mobile device as a virtual object overlaying a real-time video stream of the surrounding environment.

46. The computer program product of claim 45, wherein the virtual object is interactive.

47. The computer program product of claim 38, wherein the mobile device is operated in the “always on” mode to continuously analyze the surrounding environment.

48. The computer program product of claim 37, wherein the at least one predetermined object comprises at least one of a product or a service.

49. The computer program product of claim 37, wherein the at least one predetermined object is a business.

50. The computer program product of claim 49, wherein the business is identified due to the business being a seller of at least one of a product or a service.

51. The computer program product of claim 37, wherein the user is alerted via at least one of an audible sound, vibration, or a combination thereof.

52. The computer program product of claim 38, wherein the one or more computer-readable code portions are further configured for presenting the user with an option to purchase at least one of a product or a service.

53. The computer program product of claim 38, wherein the one or more computer-readable code portions are further configured for transmitting payment information via a wireless connection between the mobile device and a contactless payment terminal.

54. The computer program product of claim 37, wherein the one or more computer-readable code portions are further configured for transmitting financial data and/or other user-specific data to a financial institution.
